(19) United States
(12) Patent Application Publication
(10) Pub. No.: US 2024/0055618 A1
(43) Pub. Date: Feb. 15, 2024

(54) METHOD FOR PRODUCING A BIPOLAR PLATE FOR AN ELECTROCHEMICAL CELL, AND BIPOLAR PLATE

(71) Applicant: Schaeffler Technologies AG & Co. KG, Herzogenaurach (DE)

(72) Inventors: Mehmet Oete, Nurnberg (DE); Nazlim Bagcivan, Nurnberg (DE); Ladislaus Dobrenizki, Hochstadt (DE)

(73) Assignee: Schaeffler Technologies AG & Co. KG, Herzogenaurach (DE)

(21) Appl. No.: 18/267,294

(22) PCT Filed: Dec. 7, 2021
(86) PCT No.: PCT/DE2021/100976

§ 371 Date: Jun. 14, 2023

(30) Foreign Application Priority Data
Dec. 15, 2020 (DE) 10 2020 133 553.9

(51) Int. Cl. H01M 8/0245; H01M 8/0258

(52) U.S. Cl. CPC H01M 8/0245; H01M 8/0258; H01M 2008/1095

(57) ABSTRACT

A method for producing a bipolar plate for an electrochemical cell, wherein a fluid-impermeable carrier is provided and a fluid-impermeable coating is applied to at least one subregion of a surface of the carrier, wherein the coating is applied by at least one of cold gas spraying, plating, in particular roll cladding, or high-velocity flame spraying, in particular with air or oxygen as a combustion gas. A bipolar plate for an electrochemical cell.

### CROSS-REFERENCE TO RELATED APPLICATIONS

This application is the U.S. National Phase of PCT Appln. No. PCT/DE2021/100976, filed Dec. 7, 2021, which claims the benefit of German Patent Appln. No. 102020133553.9, filed Dec. 15, 2020, the entire disclosures of which are incorporated by reference herein.

### TECHNICAL FIELD

The disclosure relates to a method of producing a bipolar plate for an electrochemical cell, wherein a fluid-impermeable carrier is provided and a fluid-impermeable coating is applied to at least one subregion of a surface of the carrier. The disclosure also relates to a bipolar plate for an electrochemical cell.

### BACKGROUND

Electrochemical cells known from the prior art are generally based on an arrangement of two electrodes, which are connected to one another in a conductive manner by means of an ion conductor. Important examples of such cells are electrolysis cells or fuel cells, as well as accumulators for storing electrical energy. A common design for electrolysis cells or fuel cells are polymer electrolyte membrane cells, in which the ion conductor is formed by a proton-permeable polymer membrane (PEM, “proton exchange membrane” or “polymer electrolyte membrane”), through which the hydrogen ions formed at the anode move to the cathode and there either form molecular hydrogen (electrolysis cell) or react with the oxygen reduced at the cathode to form water (fuel cell). The electrochemically active core of a PEM cell is the membrane electrode assembly (MEA), which consists of a solid polymer membrane, which is coated on both sides with electrode material. The membrane electrode assembly is in turn part of a sandwich structure in which the two electrodes can each rest against a current collector, which in turn has a bipolar plate arranged thereon. The bipolar plates have a flow structure (flow field) on their surface facing the respective current collector, via which the base substance (e.g., water or hydrogen and oxygen gas) is fed into the cell. By stringing together several cells of the MEA, current collectors, and bipolar plates, cell stacks can be formed, using which the performance of the system can be multiplied accordingly. Bipolar plates are also used in rechargeable energy storage cells. An example of this is metal-air batteries, in which a metallic anode oxidizes with atmospheric oxygen while discharging and a corresponding reduction reaction takes place during charging. Similar to electrolysis cells and fuel cells, the bipolar plate can have a flow structure via which the oxygen can be supplied or removed.

Of the main components mentioned, it is the interconnectors (bipolar plates and current collectors) in particular that make up the main part of the production cost of such a cell. Due to the different operating conditions on the anode and cathode sides, the bipolar plates and current collectors on both sides can be made of different materials, wherein the highly corrosive operating conditions effected by the high potentials and the required high conductivity place special demands on the material. A common material here is, in particular, titanium, which is characterized by excellent corrosion resistance, but on the other hand is associated with high production costs. Another possibility is to improve the surface properties of the bipolar plate by means of appropriately selected coatings. Plasma-based methods for coating bipolar plates are known, for example, from DE 10 2014 109 321 A1 and the publications “Bipolar plates materials for polymer electrolyte membrane electrolysis” (dissertation by M. Langemann, Forschungszentrum Jülich 2016) and “Development and integration of novel components for polymer electrolyte membrane (PEM) electrolyzers” (dissertation by P. Lettenmeyer, Universität Stuttgart 2018).

A high-pressure plasma beam coating method for coating electrode surfaces is known from DE 10 2006 031 791 A1.

DE 10 2013 213 015 A1 describes a method for producing a bipolar plate, in which a layer is applied to a substrate by means of a plasma spraying method.

### SUMMARY

Against this background, an object is to provide a production method for a bipolar plate that meets the special material requirements for electrochemical applications and can be produced in a cost-effective manner.

The object is achieved by a method for producing a bipolar plate for an electrochemical cell, wherein a fluid-impermeable carrier is provided and a fluid-impermeable coating, in particular a metallic or ceramic coating, is applied to at least one subregion of a surface of the carrier, wherein the coating is applied by means of cold gas spraying, plating, or high-velocity flame spraying.

The coating consists, for example, of a ductile material and is applied by cold gas spraying (“cold gas dynamic spray” or simply “cold spray, CGDS, CS”), particularly preferably with nitrogen and/or helium as the process gas, high-velocity flame spraying, especially preferably with air or oxygen as the combustion gas (HVAF, high-velocity air fuel or HVOF, high-velocity oxygen fuel) or by means of plating, preferably by rolling on metal layers (e.g., roll weld cladding), welding on, ion plating, electroplating, dipping or explosive plating.

In high-velocity flame spraying, the coating material is preferably melted on as a powdery spray additive and applied to the surface of the carrier by means of a carrier gas in order to form a dense coating with high adhesive strength and low porosity. For example, nitrogen is suitable as a carrier gas, while the thermal energy is generated by burning propane, propylene or hydrogen with the addition of oxygen (HVOF) or air (HVAF).

In cold gas spraying, particles of the coating material are sprayed onto the surface in a non-melted state by means of a carrier gas such as nitrogen and/or helium, thus creating an extremely dense, virtually oxide-free layer with good adhesion.

In plating, the surface is preferably first cleaned, prepared by brushing or grinding, and the coating material is then bonded to the carrier in a materially integral manner by rolling under high pressure.

By means of these coating methods, it is advantageously possible to create a low-oxide and low-porosity layer that meets the special requirements for use in an electrochemical cell, wherein the material costs are reduced accordingly by replacing the solid material of titanium, titanium alloys, etc. with a lower-cost carrier material.

Preferably, the coating has at least one of the following materials or oxides or carbides thereof: titanium (Ti), niobium (Nb), tantalum (Ta), molybdenum (Mo), tin (Sn), silver (Ag), copper (Cu), gold (Au), platinum (Pt), vanadium (V), aluminum (Al), ruthenium (Ru), nickel (Ni), silicon (Si), tungsten (W). In particular, the coating can be formed by a carbide layer, for example of silicon carbide (SiC) or tungsten carbide, in particular tungsten monocarbide (WC) or a ceramic produced therefrom. Various oxide or oxide-ceramic coatings are also possible, such as substoichiometric titanium oxides, doped oxides or mixed oxides.

According to an advantageous embodiment of the disclosure, the coating has titanium or a titanium alloy, wherein the titanium alloy has at least one of the following materials or oxides or carbides thereof: niobium, tantalum, molybdenum, tin, silver, copper, gold, platinum, vanadium, aluminum, ruthenium, nickel, silicon. In this way, a corrosion-resistant surface with good electrical conductivity can be realized, wherein the material expense is advantageously relatively low compared to a plate made of the corresponding solid material.

The fluid-impermeable carrier is preferably formed of an electrically conductive material. Preferably, the carrier is metallic, in particular made of stainless steel, or made of an electrically conductive polymer material. Austenitic stainless steels, nickel-based stainless steels, copper, aluminum or even graphite, composite materials, electrically conductive thermoplastics or thermosets are particularly suitable as base materials for the carrier.

In a preferred embodiment of the disclosure, during the application of the coating, a composition of coating material applied to the surface and/or one or more process parameters and/or a spray additive is/are changed. Preferably, a gradual change in the constituents or chemical composition of the layer occurs with increasing layer thickness, whereby the layer properties can be improved in a targeted manner. A similar improvement can also be realized by changing one or more process parameters or by changing the spray additive. The change can take place gradually over the layer thickness or be created by a multi-layer application.

In order to feed the base substances required for the electrochemical reaction into the cell or to remove the corresponding reaction products, the bipolar plate preferably has a profile designed as a flow structure (flow field). This flow structure is preferably formed by channel-shaped depressions on the surface, which can, for example, run in a straight line or in a meandering manner (parallel meander flow field). Preferably, the flow structure has a plurality of separate channels, which particularly preferably run parallel to one another. The production method according to the disclosure allows for several variants to form flow channels of this type. In particular, the channels can be created before, after and during the coating process.

According to an advantageous embodiment of the disclosure, flow channels are formed on the surface of the fluid-impermeable carrier before the application of the coating. The flow channels can be created, for example, by tensile-compressive forming, in particular hydroforming. In this process, a plate or sheet is inserted between an upper and lower tool, wherein the upper tool has the desired profile to which the workpiece conforms under the action of a high-pressure fluid. Alternatively, forming can also be carried out, for example, by a purely mechanical forming process such as deep drawing, stamping or extrusion. It is also conceivable to create the channels by means of an ablative method such as machining, in particular milling.

Preferably, the coating is applied to elevations formed between the flow channels and the depressions formed by the flow channels remain uncoated. Once the flow channels have been formed on the surface of the carrier, it is advantageously possible during the subsequent coating to coat only the ridges (elevations) of the structures, but to leave the depressions of the individual structures uncoated. When using a spraying method, the local coating can be achieved in particular by an appropriate targeted movement of the nozzles using which the material is sprayed onto the carrier. When using a plating method, the coating material is first arranged on the subregions of the surface to be coated and then bonded to it in a form-fitting manner, e.g., by rolling.

In a further advantageous embodiment of the disclosure, after the application of the coating, flow channels are formed on the surface of the coated carrier by an ablative or forming method. In this production variant, the surface of the fluid-impermeable carrier is first partially or completely coated and the flow channels on the surface are then created by means of forming or material removal. Forming can be carried out in particular by means of tensile-compressive forming, preferably hydroforming, stamping or pressing. Alternatively, the channels can be formed by means of an ablative method, in particular a machining method, wherein in particular only those subregions are ablated that were not covered when the coating was applied.

In a further advantageous embodiment of the disclosure, flow channels are formed on the surface of the fluid-impermeable carrier during the application of the coating. In particular, the material is applied by spraying, so that flow fields can be created on the carrier surface by means of targeted guidance of the spray nozzles. This allows an almost freely selectable geometrical design of the flow structure and enables an advantageous reduction of the process steps in the production of the bipolar plate.

Preferably, the coating is applied in first subregions of the surface to form elevations and is not applied to second subregions of the surface to form flow channels designed as depressions on the surface of the fluid-impermeable carrier. In this production variant, the ridges of the flow fields are formed by sprayed-on material or by layers applied by means of plating, so that the uncoated regions lying between the ridges form channel-shaped depressions on the surface of the bipolar plate.

In a preferred embodiment of the disclosure, a first layer is applied to the surface of the fluid-impermeable carrier, wherein subsequently at least one further layer is applied to subregions of the first layer in such a manner that flow channels are formed on the surface of the carrier between the elevations created by the further layer. In other words, the spatial contour of the surface is created by the amount of material applied locally. In particular, a relatively freely selectable height profile can be created layer by layer in a spraying method by appropriate control of the nozzles, the depressions of which form the flow channels of the bipolar plate. The surface of the carrier can thus be protected and a surface profile be created at the same time.

According to an advantageous embodiment, particles are applied to the surface of the fluid-impermeable carrier or the coated fluid-impermeable carrier after and/or during the application of the coating, wherein the particles have an electrically conductive material and, in particular, reduce the contact resistance at the surface of the coated carrier. In particular, the particles are deposited on the surface of the fluid-impermeable carrier or in an intermediate layer as a spray additive, wherein the particles are preferably applied in a manner that is not area-covering. Particularly preferably, the particles are sporadically distributed on the surface after application. A partial covering of the surface with electrically conductive material can already be sufficient to significantly reduce the contact resistance of the bipolar plate. For example, the conductive particles can have a metal such as silver or a silver alloy, or be made of carbon or carbon modifications such as graphite. Along with the conductive particles, a binding agent can also be applied to bond the particles to the surface.

A further object of the disclosure is a bipolar plate produced by an embodiment of the method according to the disclosure. With the bipolar plate, the same technical effects and advantages can be achieved as have been described in connection with the method according to the disclosure.

A further aspect of the disclosure relates to a polymer electrolyte membrane cell having two bipolar plates, a membrane electrode assembly, and two current collectors, which are each arranged between a bipolar plate and the membrane electrode assembly, wherein at least one of the two bipolar plates is produced by means of an embodiment of the method according to the disclosure. The bipolar plate according to the disclosure can be arranged on only one side of the membrane electrode assembly or on both sides. In particular, it can be arranged on the anode side, where very high corrosion resistance is required due to the high ion concentration at the anode.

The PEM cell can be designed both as a PEM electrolysis cell and as a PEM fuel cell.

Furthermore, a further aspect of the disclosure relates to a metal-air cell, in particular a lithium-air accumulator, in which the bipolar plate according to the disclosure is arranged on a metallic anode.

A further aspect of the disclosure relates to an electrolyzer or fuel cell assembly having at least one cell stack formed from a plurality of cells, wherein the cells are each embodiments of the polymer electrolyte membrane cell according to the disclosure. Preferably, the cell stack has two end plates with which the stack is held under a mechanical compressive stress to ensure close contact of the components. A further aspect of the disclosure relates to a metal-air energy storage unit, in particular a lithium-air energy storage unit, having at least one cell stack formed from a plurality of metal-air cells, wherein the cells are each embodiments of the metal-air cell according to the disclosure.

### BRIEF DESCRIPTION OF THE DRAWINGS

Further details and advantages of the disclosure will be explained below with reference to the exemplary embodiment shown in the drawings. In the figures:

FIG. 1 shows two exemplary embodiments of an electrochemical cell in a schematic representation;

FIG. 2 shows four exemplary embodiments of the bipolar plate according to the disclosure in a schematic representation;

FIG. 3 shows an exemplary embodiment of the method according to the disclosure in a schematic representation;

### DETAILED DESCRIPTION

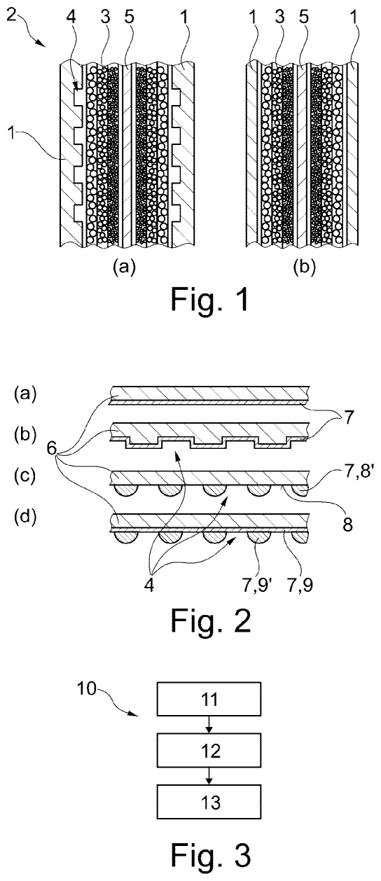

FIG. 1 schematically shows an example of a typical structure of an electrochemical cell 2 designed as a polymer electrolyte membrane cell. The membrane electrode assembly (MEA) 5 is centrally arranged in the cell 2, which is adjacent on each side to a current collector 3 and a bipolar plate 1. Via a flow structure 4 on the surface of the bipolar plates 1, the base substances for the electrochemical reaction are introduced into the cell 2, which then flow through the porous current collectors 3 to the MEA 5, where they are converted into the reaction products. The PEM cell 2 can be either an electrolysis cell or a fuel cell. In electrolysis, the base substance is water, which is broken down into hydrogen and oxygen at the MEA 5 by electrochemical splitting. In a fuel cell, on the other hand, the base substances hydrogen and oxygen are converted into water, releasing electrical energy.

For this purpose, the MEA 5 consists of a polymer-based proton-permeable membrane, which is coated on both sides with electrode/catalyst material. Hydrogen ions are formed at the anode by means of the catalyst, which migrate through the membrane of the MEA 5 to the opposite cathode layer, where they form water in the case of the fuel cell or gas of molecular hydrogen in the case of the electrolysis cell. The current collectors 3 not only provide the transport path for the base substances flowing towards the MEA 5 and the outflowing reaction product, but also ensure the electrical contacting of the MEA 5. Due to the high ion concentration, highly corrosive conditions prevail in the vicinity of the catalyst/electrode layers of the MEA 5, which place special demands on the material of the current collectors 3 and the bipolar plates 1.

According to the disclosure, at least one of the bipolar plates 1 is formed by applying a coating 8 to a fluid-impermeable carrier 6. Titanium or titanium alloys are particularly favorable here due to their good corrosion resistance. In the embodiment shown in FIG. 1a, flow channels 4 are formed on the surface of the bipolar plates 1, while the bipolar plate shown in FIG. 1b has no channels. Similarly, bipolar plates can be used in other electrochemical cells, such as accumulators.

In FIG. 2, various options for structuring and/or coating the bipolar plate 1 according to the disclosure are shown. In the embodiment shown in FIG. 2a, a fluid-impermeable coating 7 is applied to a substantially flat surface of a fluid-impermeable carrier 6. In the embodiment shown in FIG. 2b, flow structures 4 were formed on the surface of the fluid-impermeable carrier 6 prior to the coating, and a fluid-impermeable coating 7 was applied to the entire structured surface of the carrier 6 in a subsequent step. Alternatively, it is also possible to coat only the elevations formed between the flow channels 4 and leave the depressions uncoated. In the variant shown in FIG. 2c, only subregions 8′ of the fluid-impermeable carrier 6 are coated, so that the intermediate, uncoated subregions 8 form the flow channels 4. In the embodiment shown in FIG. 2d, the entire surface of the fluid-impermeable carrier 6 is initially coated with a first layer 9′, while a further layer 9 is applied only in certain subregions, so that a flow structure 4 is created by the different thicknesses of the fluid-impermeable coating 7. Such a layer system consisting of two or more layers 9, 9′ allows for a relatively freely designable height profile to be created on the surface of the fluid-impermeable carrier 6. According to the disclosure, the fluid-impermeable coating 7 is applied by means of cold gas spraying, plating, in particular roll cladding, or high-velocity flame spraying, in particular with air or oxygen as a combustion gas.

FIG. 3 shows the various method steps 11, 12, 13 of a possible embodiment of the method 10 according to the disclosure for producing a bipolar plate 1. In the first step 11, a fluid-impermeable carrier 6, for example made of stainless steel or a polymer material, is provided. In a second step 12, a fluid-impermeable coating 7 is deposited on a surface of the carrier 6. The coating 7 consists of a ductile material, e.g., titanium or a titanium alloy, which is applied by cold gas spraying, (roll) cladding or high-velocity flame spraying (HVOF or HVAF). The coating 7 is formed by a single- or multi-layer coating system, with or without flow structures 4 formed on the surface. The coating 7 can be applied to the existing flow fields 4, wherein, however, it is also possible to apply the structures for creating the flow field 4 directly to the substrate surface without an area-covering coating. In an optional third method step 13, conductive particles (for example as a spray additive) are applied to the surface of the fluid-impermeable carrier 6 or an intermediate layer. The application is preferably not area-covering, so that the particles are sporadically distributed on the surface. Such a proportional coverage of the surface with electrically conductive materials can advantageously reduce the contact resistance of the bipolar plate 1.

### LIST OF REFERENCE SYMBOLS

1 Bipolar plate
2 Electrochemical cell
3 Current collector
4 Flow channels
5 Membrane electrode assembly
6 Fluid-impermeable carrier
7 Fluid-impermeable coating
8 Uncoated subregion
8′ Coated subregion
9 First layer
9′ Further layer
10 Production method
11 Providing the carrier
12 Applying the coating
13 Applying conductive particles

1. A method for producing a bipolar plate for an electrochemical cell comprising: applying a fluid-impermeable coating to at least one subregion of a surface of a carrier, wherein the coating is applied by at least one of cold gas spraying, plating, roll cladding, or high-velocity flame spraying with air or oxygen as a combustion gas.

2. The method according to claim 1, wherein the coating includes at least one of titanium, niobium, tantalum, molybdenum, tin, silver, copper, gold, platinum, vanadium, aluminum, ruthenium, nickel, silicon, tungsten, or oxides or carbides thereof.

3. The method according to claim 2, wherein the coating includes at least one of titanium or a titanium alloy, wherein the titanium alloy includes at least one of niobium, tantalum, molybdenum, tin, silver, copper, gold, platinum, vanadium, aluminum, ruthenium, nickel, silicon, or oxides or carbides thereof.

4. The method according to claim 1, wherein the carrier is formed of an electrically conductive material.

5. The method according to claim 1, wherein during the application of the coating, at least one of a composition of coating material applied to the surface, at least one process parameter, or a spray additive is changed.

6. The method according to claim 1, further comprising forming flow channels on the surface of the carrier prior to applying the coating.

7. The method according to claim 6, wherein the coating is applied to elevations between the flow channels and depressions of the flow channels remain uncoated.

8. The method according to claim 1, further comprising, after applying the coating, forming flow channels on the surface of the coated carrier by an ablative or forming method.

9. The method according to claim 1, further comprising forming flow channels on the surface of the carrier during the application of the coating.

10. The method according to claim 9, wherein the coating is applied in first subregions of the surface to form elevations and is not applied in second subregions of the surface to form flow channels comprising depressions on the surface of the carrier.

11. The method according to claim 9, wherein a first layer of the coating is applied to the surface of the carrier, wherein subsequently at least one further layer is applied to subregions of the first layer in such a manner that flow channels are formed on the surface of the carrier between elevations created by the further layer.

12. The method according to claim 1, further comprising applying particles to at least one of the surface of the carrier or the coating after or during applying the coating, wherein the particles include an electrically conductive material and reduce a contact resistance at the surface of the coated carrier.

13. A bipolar plate for an electrochemical cell made by the method of claim 1.

14. A bipolar plate for an electrochemical cell comprising:
a carrier; and
a fluid-impermeable coating on at least one subregion of a surface of the carrier.

15. The bipolar plate according to claim 14, wherein the coating includes at least one of titanium, niobium, tantalum, molybdenum, tin, silver, copper, gold, platinum, vanadium, aluminum, ruthenium, nickel, silicon, tungsten, or oxides or carbides thereof.

16. The bipolar plate according to claim 15, wherein the coating includes at least one of titanium or a titanium alloy, wherein the titanium alloy includes at least one of niobium, tantalum, molybdenum, tin, silver, copper, gold, platinum, vanadium, aluminum, ruthenium, nickel, silicon, or oxides or carbides thereof.

17. The bipolar plate according to claim 14, wherein the carrier comprises an electrically conductive material.

18. The bipolar plate according to claim 14, further comprising flow channels on the surface of the carrier.

19. The bipolar plate according to claim 18, wherein the coating is on first subregions of the surface and forms elevations and wherein no coating is on second subregions of the surface, and wherein the flow channels correspond to the second subregions.

20. The bipolar plate according to claim 14, further comprising a first layer of the coating and a further layer of the coating.
